(19) United States
(12) Patent Application Publication
(10) Pub. No.: US 2013/0207572 A1
(43) Pub. Date: Aug. 15, 2013

(54) SOUND CONTROLLED LIGHT EMITTING DEVICE AND METHOD

(71) Applicant: Tucker Design LLC, (US)

(72) Inventors: Allen W. Tucker, San Diego, CA (US); Zachary Beau Simmons, San Diego, CA (US)

(73) Assignee: TUCKER DESIGN LLC, San Diego, CA (US)

(21) Appl. No.: 13/761,426

(22) Filed: Feb. 7, 2013

Related U.S. Application Data
(60) Provisional application No. 61/597,085, filed on Feb. 9, 2012.

(51) Int. Cl. H05B 37/02

(52) U.S. Cl. CPC H05B 37/02
USPC 315/297

(57) ABSTRACT

A light pole is described, including an elongated member having a core and an outer shell, with light emitting elements positioned along the length of member between the core and outer shell, and a control module controlling color and intensity of light output from the light emitting elements to provide different or varying light output modes. The outer shell is partially transparent or translucent for transmission of at least some light emitted from the light emitting elements.

### CROSS-REFERENCE TO RELATED APPLICATIONS

This application claims the benefit of U.S. provisional app. Ser. No. 61/597,085, filed Feb. 9, 2012, entitled A Flashing, Color Changing, Solid Color, Light Emitting Pole that Syncs to an Input Source. The above provisional application is hereby incorporated by reference.

### BACKGROUND

1. Related Field

The subject matter discussed herein relates generally to a lighting device and more particularly to a sound controlled light emitting device or apparatus.

2. Related Background

Dance clubs and other adult entertainment establishments typically include lighting and music, and may also have light poles extending from the floor to the ceiling which are typically a single color over their entire length. Some poles in such establishments may have reflective surface areas that reflect light from the surrounding or nearby light sources.

### SUMMARY

According to one embodiment, a sound controlled, light emitting device is provided which comprises an elongated member or pole having a longitudinally extending core and a plurality of light emitting elements arranged along the length of the core, and a lighting controller associated with the light emitting elements and configured to vary one or more of the color and intensity or brightness of the light emitting elements.

In one embodiment, the lighting controller is part of a control system which includes an audio signal receiver and transducer which converts incoming audio signals into corresponding electrical control signals and provides the control signals to the lighting controller. The lighting controller is configured to control operation of the light emitting elements based on the control signals. In one embodiment, output color and brightness or intensity of the light output are controlled in response to incoming audio signals so that the lights flash and change color in synchronism with the beat of the music. The lights may also be controlled to change color with the music, and to change in intensity and become brighter in response to increasing intensity of the music, for example becoming brighter or more intense in a louder portion of the music, and less bright or dimmer in quieter portions of a piece of music or a song, or changing in color or having different multiple color patterns which vary based on a musical input. The control system may include a user input for user adjustment of the lighting controller to provide different modes or patterns of lighting adjustments and sequences based on the incoming audio signals in which different colors or combinations of colors are emitted along the length of the pole, or the pole switches between different solid colors or multiple colors or intensities of lights, or flashes on and off and the like. In this way, a disc jockey can adjust the light output patterns for different songs.

In one embodiment, the light emitting elements may be two or more multi-color or color varying strips of light emitting diodes (LEDs), and the strips may be arranged in a spiral pattern around the outside of the core, or multiple strips may extend linearly along the length of the core, or in other patterns. Other types of different colored lighting may be used in alternative embodiments. The lighting controller may be arranged to control different sectors or zones along the length or around the periphery of the core independently, so as to create desired visual effects.

In one embodiment, the elongated member may be a generally cylindrical light emitting pole, and a cylindrical outer sleeve or cover may extend around and along at least a portion of the core, or the entire core. The pole may be of non-cylindrical shapes in other embodiments. The outer sleeve may be of translucent or transparent material along at least part of its length or its entire length. This protects the lighting elements while allowing colored light to be transmitted radially around the entire circumference of the pole. The outer sleeve may act as a light diffuser or filter in one embodiment, or a separate light diffusing film or device may be provided between the LEDs and the outer sleeve.

This arrangement results in an attractive, visually appealing lighting effect for music clubs and the like, where a plurality of multi-color, flashing and pulsating light poles may be arranged across the dance floor or one or more such poles may be provided on a stage for dancers. Such poles may also be provided in display windows of such venues in order to attract customers.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a side elevation view of one embodiment of a light emitting pole.

FIG. 1B is a longitudinal cross sectional view of the pole on the lines 1B-1B of FIG. 1A.

FIG. 1C is a front elevation view of the pole of FIGS. 1A and 1B with part of the outer sleeve cut away to reveal the light emitting elements; and

FIG. 2 is a functional block diagram of one embodiment of a control system for controlling operation of the light emitting elements in the light pole of FIG. 1A to 1C.

### DETAILED DESCRIPTION

This invention relates generally to attractive light emitting devices such as poles for use in dance clubs, bars, and other adult entertainment venues, and is particularly concerned with a light emitting pole arranged to flash and change colors and/or intensity in synchronism with an input source such as an audio input.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

The subject matter described herein is taught by way of examples. The embodiments described below are directed to structures and functions of light emitting devices such as light poles (i.e., poles with the capability to emit light when one or more light emitting elements are turned on).

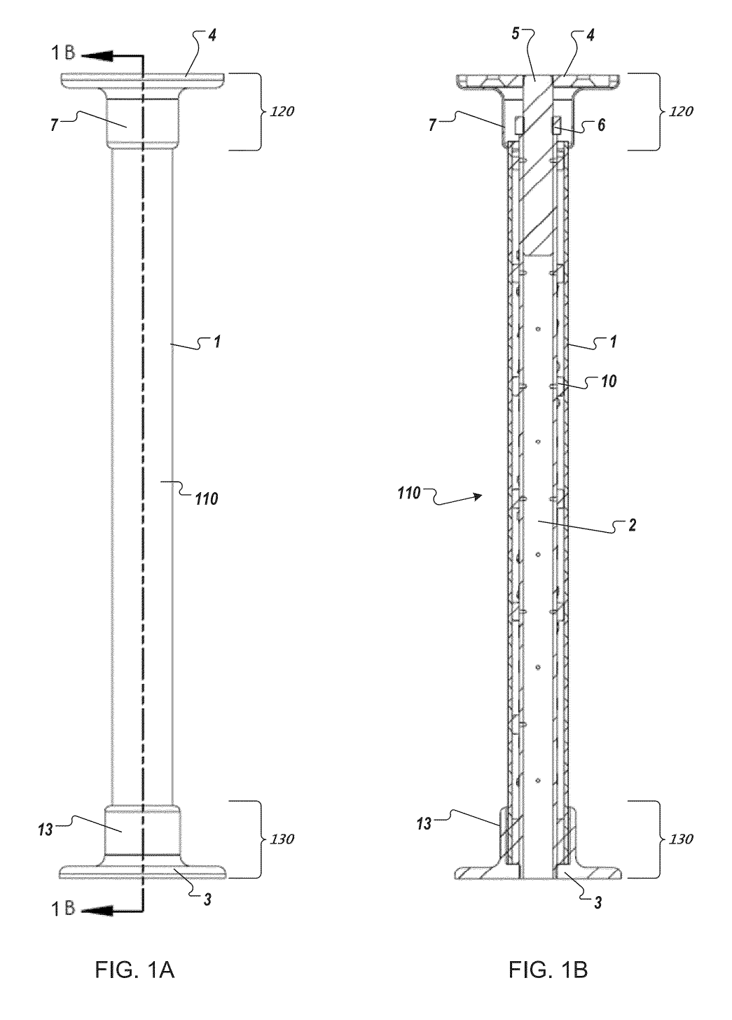

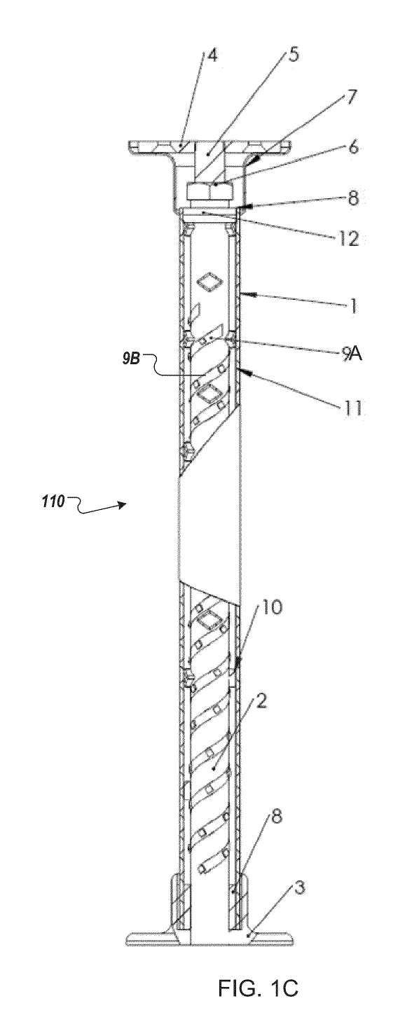

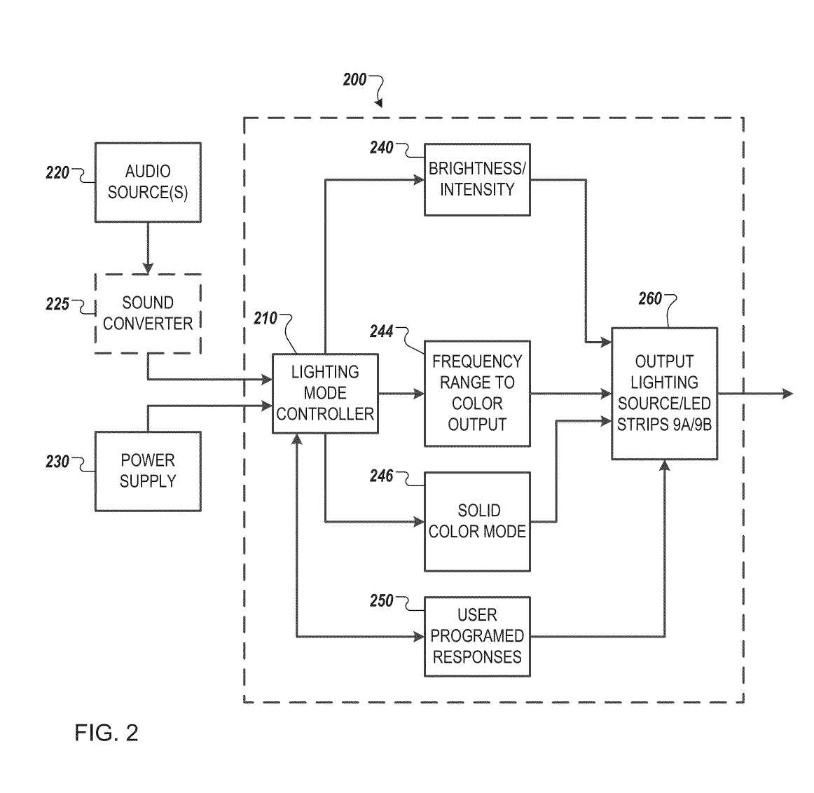

FIG. 1A to 1C illustrate one embodiment of an elongated light emitting member or pole 110, while FIG. 2 illustrates one embodiment of a control system linked to lighting elements in the pole for controlling their operation, as described in more detail below. Pole 110 has an upper mount assembly 120 and a lower mount assembly 130. Pole 110 may be assembled from two or more sections with hardware (not shown) that interconnect or lock the sections into one integral unit. In the illustrated embodiment, pole 110 comprises an outer shell or sleeve 1 of transparent or translucent material and an inner or central core 2 extending between the upper and lower mount assembly and spaced from the sleeve 1 by a series of spacers 10 extending between the core and the inner surface of sleeve 1. Spacers 10 couple outer shell 1 with core structure 2 and provide a space or gap for installing light emitting elements 9A and 9B, as described in more detail below.

In one embodiment, a light diffuser 11 such as a diffuser coating, film, or surface treatment is provided on the inner surface of sleeve 1 or between the sleeve and light emitting elements. Alternatively, the sleeve may be configured to act as a diffuser or filter. In this embodiment, the outer shell or sleeve 1 covers the entire length of core 2, but may cover one or more portions or less than the entire length of pole 110 in other embodiments.

The outer shell or some portion of the outer shell may be smooth or may have a roughened surface for different lighting effects. Pole 110 may be in any shape or combination of shapes. For example, both the outer sleeve 1 and core 2 of the pole 110 may be cylindrical, i.e. of circular cross-section along their length between the top and lower mount assemblies 120, 130, as illustrated in FIGS. 1A to 1C. In alternative embodiments, pole 110 or some portion of it may have a square cross section or may be of other cross-sectional shapes such as oval, polygonal or other shapes, including irregular or asymmetrical shapes.

Light emitting elements 9A, 9B are mounted on the outer surface of core 2 so as to extend along some or all of the length of the core, as illustrated in FIG. 1C. In the illustrated embodiment, the light emitting elements comprise multi-color, flexible LED light strips, and two such strips 9A and 9B are arranged in interleaved helical paths along the length or part of the length of core 2. More than two such strips may be provided in alternative embodiments. Although the light emitting elements are flexible LED light strips in the illustrated embodiment, other types of multi-colored light sources may be used in alternative embodiments, such as incandescent lights, fluorescent lights, light emitting diodes (LEDs) in strings or other arrangements, other lighting elements, and any combination thereof.

The light emitting elements may be arranged in any way to extend around and along pole 110 or substantially along pole 110 (e.g., from about the lower end or lower mount assembly, if used, to about the upper end or upper mount assembly, if used). In some arrangements, there may be void spots (e.g., spots on pole 110 void of light emitting elements). In the illustrated embodiment, LED strips 9A and 9B are shown arranged in a wrapped around fashion (e.g., wrapped around inner core 2) in a helical/spiral arrangement which distributes the spaced LEDs within the strips around the entire circumference and along the entire length of the lighted portion of pole 110. Multiple LED strips or other lighting elements may alternatively be arranged around the core to extend side by side lengthwise along the core 3, or in other patterns.

In the illustrated embodiment, the pole 110 is straight or substantially straight (e.g., as measured from one end to the other end of the center axis), but may be designed with curves or bends along its length in other embodiments, to provide a different ornamental effect.

The upper mount assembly 120 may include a top mount 4 for attaching or securing one end of pole 110 to a ceiling or other mounting structure, while the lower mount assembly 3 comprises a base for standing the pole on a floor or other support surface. An optional top cover sleeve or flange 7 extends from top mount 4 for covering and concealing hardware or elements used in attaching or securing pole 110 to top mount 4, while a lower cover sleeve 13 of the lower mount assembly 130 receives the lower end of pole 110. In some designs, the top mount assembly 120 and the lower mount assembly may each be a single unit. Although pole 110 is shown in a vertical orientation in FIGS. 1A to 1C, pole 110 may be deployed in other orientations, such as horizontal, diagonal, vertical, or any orientation in between, by securing the mounting assemblies at each end between appropriate supports.

In some installations, pole 110 may be installed and used without top mount assembly 120 and/or bottom mount assembly 130. For example, one end of pole 110 may be attached or secured to a floor or through a floor in any manner which will be apparent to those skilled in the art or construction. The other end of pole 110 may be attached or secured to a ceiling or through a ceiling in any manner which will be apparent to those skilled in the art or construction.

To create a free-standing pole, pole 110 may be attached or secured to a heavy and/or stable bottom base with or without using the bottom mount assembly 130. The free-standing pole, which includes pole 110 and the base, may be portable or movable from location to location. In another example installation, one end of pole 110 may be mounted to a ceiling with our without using top mount assembly 120 with the other (e.g., bottom) end of the pole dangling (e.g., suspended in the air).

To create a rotating pole secured between two supports, pole 110 may be attached or secured to a rotatable device on the top 120 and bottom 130 mounting assemblies.

To create a rotating, free-standing pole, pole 110 may be attached or secured to a rotatable device on the bottom assembly 130.

In some alternative embodiments or installations, pole 110 may have one or both ends telescopically engaged with the upper or lower mount assembly to allow for adjustment of the total length for different height ceilings. For example, the upper end of pole 110 may be attached to an adjusting assembly 5,6, as illustrated in FIG. 1B, which is adjustable to increase or decrease the total length of pole 110 and the adjusting assembly. To detach pole 110 for maintenance, for example, the adjusting assembly may be adjusted to decrease the total length of pole 110 and the adjusting assembly.

FIG. 1B is a cross section view of the pole in FIG. 1A. Pole 110 may include an adjusting assembly, which includes a tensioning rod 5 and an adjuster or jam nut 6. Jam nut 6 is secured to the upper end of core 2, which may be hollow along part or all of its length. Tensioning rod 5 is threadably engaged with jam nut 6 and telescopically engaged in the upper end of core 2. Jam nut 6 is used to adjust (e.g., lengthen or shorten) the combined or total length of pole 110 and tensioning rod 5. An adjusting assembly other than that shown may be used as apparent to those skilled in the art. In some embodiments, anti-rotation compound 8 and seal 12 may be used (e.g., at an initial assemble stage) to assemble pole 110. For example, anti-rotation compound 8 may be used to lock, bind, or otherwise couple outer shell 1 to core 2 and/or lower mount 3 (e.g., anti-rotation compound 8 functions as spacer 10 and prevents outer shell 1 from rotating when a force is applied to it). Seal 12 may be used to contain anti-rotation compound 8 near the top mount assembly 120 and the upper end of outer sleeve 1.

Core 2 in one embodiment comprises a hollow sleeve of rigid or substantially rigid material such as metal, rigid plastic, wood, composite material, or the like, of sufficient strength to bear the load or force transferred to core 2 from one or more persons exercising, dancing, and/or climbing on pole 110. The outer shell or sleeve 1 may be of translucent or transparent, rigid or substantially rigid material such as a rigid clear or translucent plastic material or thermoplastic material or cast material. Instead of a separate diffuser layer or film 11, the inner or outer surface of the sleeve may be altered to provide a light diffusing effect.

Pole 110 may be of any length depending on the desired pole extent in a free standing pole or the ceiling height for a floor or support surface to ceiling installation. In one embodiment, the length range for a vertical installation is one foot to 32 feet. The outer shell 1 may have a diameter in the range from 1 inch to 48 inches, while the inner core may have a diameter in the range from half an inch to 46 inches. In one embodiment of a dance pole for a club or the like, the length may be in the range from around six feet to sixteen feet, the outer shell diameter may be around 1.5 to 2.0 inches while the inner core diameter may be around 1.0 inch to 1.5 inches. In other applications where the pole is used primarily for appearance and ornamental lighting effects and is not intended to be gripped while dancing, the shell and core diameters may be larger.

In some installations, light emitting elements may be grouped or separated into zones or sectors, such as light emitting elements 9A being in one sector and light emitting elements 9B being in another sector, or different parts of the length of each LED strip comprising different zones or sectors, or different regions of the core defining different zones. Other zone arrangements are readily apparent to those skilled in the art. Light emitting elements in different sectors or zones may be turned on and/or controlled independently.

At least some of the light emitting elements 9A and 9B may be in one or more colors before turning on. When turned on, some or all of the light emitting elements or LEDs in strips 9A and 9B may produce or output light in one or more colors based on an input signal. One or both LED strips may be capable of producing or outputting flashing light or changing light from one color to other colors along all or part of its length or changing in intensity from bright to dim and vice versa. The flashing or changing light may be a result of the light emitting elements being driven and/or controlled by an input signal (e.g., an audio signal and/or electrical pulses).

Light produced or output from at least some of the light emitting elements 9A and 9B may be diffused using, for example, one or more diffusers 11. Light output is diffused and shines through transparent or translucent outer shell 1. In some installations, some or all of the light emitting elements in strips 9A and 9B may have built-in diffusers 11 (e.g., diffuser caps, surface treatments, or covers). In some installations, the outer shell 1 may function as a diffuser (e.g., may comprise a translucent material that diffuses light). Spacers 10 may provide a space of predetermined size between the light emitting elements 9A and 9B and diffuser 11 (e.g., to magnify the diffusing effect).

Light emitting elements 9A and 9B may be LED light strips with built-in electrical wires that transmit electrical signals to turn on and drive the LEDs. Each strip may include one or more connectors such as plugs or sockets for connection to the control system of FIG. 2 to control switching of the LEDs on and off as well as varying their light outputs, as described in more detail below. Where two or more zones or sectors are controlled independently to produce different lighting effects, at least one connector or input for each zone is provided in the light strips.

FIG. 2 shows one embodiment of a control system 200 that may be used to control lighting in the pole of FIG. 1A to 1C. System 200 may be incorporated in the pole structure itself, for example in a base assembly, or may be a stand alone device suitably connected to the light strips inside the pole for controlling their operation, for example via wiring or via wireless interface. System 200 includes a lighting mode controller or microprocessor 210 that has a power input connected to any suitable power supply 230 and a control input which is associated with an audio source 220 via a sound converter 225 such as an audio signal transducer which converts audio input signals from audio source 220 into output control signals or electronic control signals. Sound converter 225 may be incorporated in system 200. Audio source 220 may be a music source or audio system which plays pre-recorded music and the like as provided in music clubs or other venues, or may be a live audio source such as a singer or band. There may be combination of two or more sources of audio signal.

Lighting mode controller or control module 210 may be programmed to produce output signals to drive or produce different lighting effects or LED output modes, depending on the loudness, beat or other attributes of the music being played. Lighting mode controller 210 may provide output signals with different parameters such as signal amplitude and frequency for controlling different aspects of the output light from the LEDs in light strips 9A and 9B, such as brightness or intensity signal 240, frequency range or color signal 244 which controls LED color output, and solid color mode signal 246 which changes all the lights in one sector or the entire pole to a single color. A plurality of output signals may be provided from controller 210 in some embodiments and may be used to independently drive different sections or zones of light emitting elements 260 (e.g., 9A and 9B).

Brightness or intensity signal 240 increases or decreases the intensity of the light output from the light emitting elements in a similar manner to a light dimmer switch or control. Frequency range to color signal 244 maps frequency ranges (e.g., low pass, zero or more band passes, and high pass frequency ranges) to color output (e.g., red from a low pass range, green from a band pass range, and blue from high pass range). Solid color signal 246 drives or produces solid color light output. Solid color signal 246 may change light output from one color to another color.

In one embodiment, the lighting mode controller is programmed to control the lights to synchronize one or more of intensity, color or a changing multi-color pattern in time to the beat of an incoming music signal, allowing dancers to follow the rhythm of the music visually as well as by ear. Additionally, specific zones or individual lights may be controlled independently to produce desired visual effects or patterns. Some possible lighting effects or patterns which may be produced by this system are: a visual effect of vertical or rotational movement, construction of symbols, text, or hieroglyphics.

A user may program the lighting mode controller 210 to produce desired lighting effects varying from the programmed effects, using user programmed response interface 250. For example, a user may vary the colors, intensity, or the like.

In some implementations, device 200 may be attached to or embedded in a pole assembly. Light output driving signals 240-246 are, for example, fed into light strips 9A and 9B. In other implementations, device 200 may a separate device that may be plugged in or connected to a pole. In these implementations, light output driving signals 240-246 may be aggregated by or passed through output light source 260, which has multiple outputs connected to a pole assembly for connection to light strips 9A and 9B or pre-selected sectors in the light strips 9A and 9B in a conventional manner.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A light emitting device, comprising:
an elongated member having first and second ends;
the member having an inner core and an outer shell of at least partially transparent or translucent material surrounding the core between the first and second ends and spaced from the core;
light emitting elements positioned along at least part of the length of the inner core between the core and the outer shell, the light emitting elements being configured to emit light of different colors; and
a control module configured to control operation of the light emitting elements to provide a plurality of different light output modes.

2. The device of claim 1, further comprising an audio receiver and converter module associated with the control module and configured to receive incoming audio signals from an audio source and convert the audio signals into output control signals provided to a control input of the control module, wherein the control module is configured to control operation of the light emitting elements in response to the control signals such that light emitted from at least some of the light emitting elements has parameters which are synchronized with the beat of audio from the audio source.

3. The device of claim 1, wherein the light emitting elements are configured to produce light of two or more colors.

4. The device of claim 1, wherein the light output modes comprise at least modes of different single or multiple colors and different color patterns over the length of the elongated member.

5. The device of claim 4, wherein the light output modes include modes in which different predetermined sectors of the elongated member have different light outputs.

6. The device of claim 1, wherein the control module is configured to vary one or more parameters of the output light signals from the light emitting elements, the parameters comprising at least color and intensity.

7. The device of claim 1, further comprising a user input module connected to the control module for user input of light output modes.

8. The device of claim 1, further comprising one or more spacers positioned between the core and the outer shell.

9. The device of claim 1, further comprising at least one mount attached to at least one of the two ends of the elongated member.

10. The device of claim 1, further comprising upper and lower mounting assemblies for mounting the ends of the pole on respective supports, and the ends of the pole are rotatably attached to the respective upper and lower mounting assemblies.

11. The device of claim 9, wherein the at least one mount is a base mount configured for engaging a support surface and the elongated member is a free-standing pole.

12. The device of claim 11, wherein the free-standing pole is rotatably attached to the base mount.

13. The device of claim 1, wherein the elongated member is of adjustable length and has a base mount at one end and an upper mount at the opposite end configured to secure the elongated member between a base support surface and a ceiling.

14. The device of claim 1, wherein the elongated member comprises a pole.

15. The device of claim 1, further comprising a diffuser positioned between the light emitting elements and the outer shell.

16. The device of claim 1, wherein the outer shell is a diffuser.

17. The device of claim 1, wherein the outer shell and core are substantially cylindrical members of different diameters.

18. The device of claim 1, wherein the light emitting elements are light emitting diodes (LEDs) configured to produce light of two or more colors.

19. The device of claim 18, further comprising at least two flexible LED strips incorporating the LEDs and extending along at least a major part of the length of the core.

20. The device of claim 19, wherein the LED strips extend in side-by-side spiral paths along the core.

21. A method of controlling the light output of a plurality of light emitting elements mounted on an elongated member, comprising:
distributing a plurality of light emitting elements at spaced intervals along the length and around the entire perimeter of an elongated member to produce light output in all directions from the pole;
receiving an audio input at a sound converter module;
converting the audio input into an electronic output control signal which varies with changing amplitude and frequency of the audio input;
receiving the control signal at a lighting mode controller; and
changing at least one of the color and intensity of light emitted from the light emitting elements to produce different light output modes based on changes in the audio input.

22. The method of claim 21, wherein the elongated member is a pole comprising a central core and a translucent or transparent outer shell, the light emitting elements are positioned in a plurality of sectors along and around the core, and the lighting mode controller is configured to independently drive light output from the plurality of sectors to produce different lighting effects in each sector of the pole.
